(19) United States
(12) Patent Application Publication
(10) Pub. No.: US 2006/0116174 A1
(43) Pub. Date: Jun. 1, 2006

(54) Mobile telephone device and telephone method using mobile telephone device

(75) Inventor: Kenichi Ide, Akishima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/289,350

(22) Filed: Nov. 30, 2005

(30) Foreign Application Priority Data
Nov. 30, 2004 (JP) 2004-347314

(51) Int. Cl. H04B 1/38

(52) U.S. Cl. 455/566

(57) ABSTRACT

A mobile telephone device includes a communication part configured to perform wireless communication with an external mobile telephone device M, a talking part configured to make a call to the external mobile telephone device by modulating a voice signal from a vocoder, transmitting it from the communication part, demodulating the voice signal received by the communication part, and reproducing it by a speaker, a display part configured to display an image, and a control part configured to display information related to an operational mode of the mobile telephone device of a sender together with an incoming notice if there is this information among the communication information of which incoming is detected by the communication part and to control the mobile telephone device so as to wait for an operation for talking.

### CROSS-REFERENCE TO RELATED APPLICATIONS

This application is based upon and claims the benefit of priority from prior Japanese Patent Application No. 2004-347314, filed Nov. 30, 2004, the entire contents of which are incorporated herein by reference.

### BACKGROUND OF THE INVENTION

1. Field of the Invention

The present invention relates to a mobile telephone device and, particularly, the present invention relates to a mobile telephone device, which adds and transmits sender information such as the operation mode upon calling together with a telephone signal and a telephone method.

2. Description of the Related Art

In recent years, in accordance with development of a digital technology, a cellular phone has been widely used. As such a cellular phone, one having the positional information of a sender, for example, a GPS (Global Position System) loaded has been known.

In patent document 1 (Jpn. Pat. Appln. KOKAI Publication No. 2003-309876), it is disclosed that a GPS processing unit is loaded on the cellular phone and the positional information of the sender is noticed at the request of a party. Here, the sender does not always notice his or her positional information but notices it under a predetermined condition, and thereby, the security of personal information can be kept.

However, in the patent document 1 relating to a conventional art, it is only indicated that the GPS information is transmitted and this involves a problem that it is not particularly indicated to notice other information such as the operation mode of the sender upon incoming.

### BRIEF SUMMARY OF THE INVENTION

A mobile telephone device according to one embodiment of the present invention comprises: a communication part configured to perform wireless communication with an external mobile telephone device; a talking part configured to make a call to the external mobile telephone device by modulating a voice signal from a vocoder, transmitting it from the communication part, demodulating the voice signal received by the communication part, and reproducing it by a speaker; a display part configured to display an image in accordance with communication information received by the communication part through wireless communication; and a control part configured to display information related to an operational mode of the mobile telephone device of a sender together with an incoming notice if there is this information among the communication information of which incoming is detected by the communication part and to control the mobile telephone device so as to wait for an operation for talking.

### BRIEF DESCRIPTION OF THE SEVERAL VIEWS OF THE DRAWING

FIG. 1 is a block diagram showing an example of the configuration of a mobile telephone device according to an embodiment of the present invention;

FIG. 2 is an explanatory view for explaining an example of the condition in which the mobile telephone device according to the embodiment of the present invention makes a call to another mobile telephone device;

FIG. 3 is a view showing an example in which the mobile telephone device according to the embodiment of the present invention displays map information in accordance with a face image and GPS positional information;

FIG. 4 is a view showing an example in which the mobile telephone device according to the embodiment of the present invention displays the face information and a usage condition;

FIG. 5 is a view showing an example in which the mobile telephone device according to the embodiment of the present invention displays the map information in accordance with the face image and the positional information;

FIG. 6 is a view showing an example in which the mobile telephone device according to the embodiment of the present invention displays the map information in accordance with the positional information;

FIG. 7 is a flow chart showing an example of the processing of the mobile telephone device upon calling according to the embodiment of the present invention;

FIG. 8 is a flow chart showing an example of the processing of the mobile telephone device upon incoming and talking according to the embodiment of the present invention;

FIG. 9 is a flow chart showing another example of the processing of the mobile telephone device upon calling according to the embodiment of the present invention; and

FIG. 10 is a flow chart showing another example of the processing of the mobile telephone device upon incoming and talking according to the embodiment of the present invention.

### DETAILED DESCRIPTION OF THE INVENTION

The embodiments of the present invention will be specifically described below with reference to the drawings.

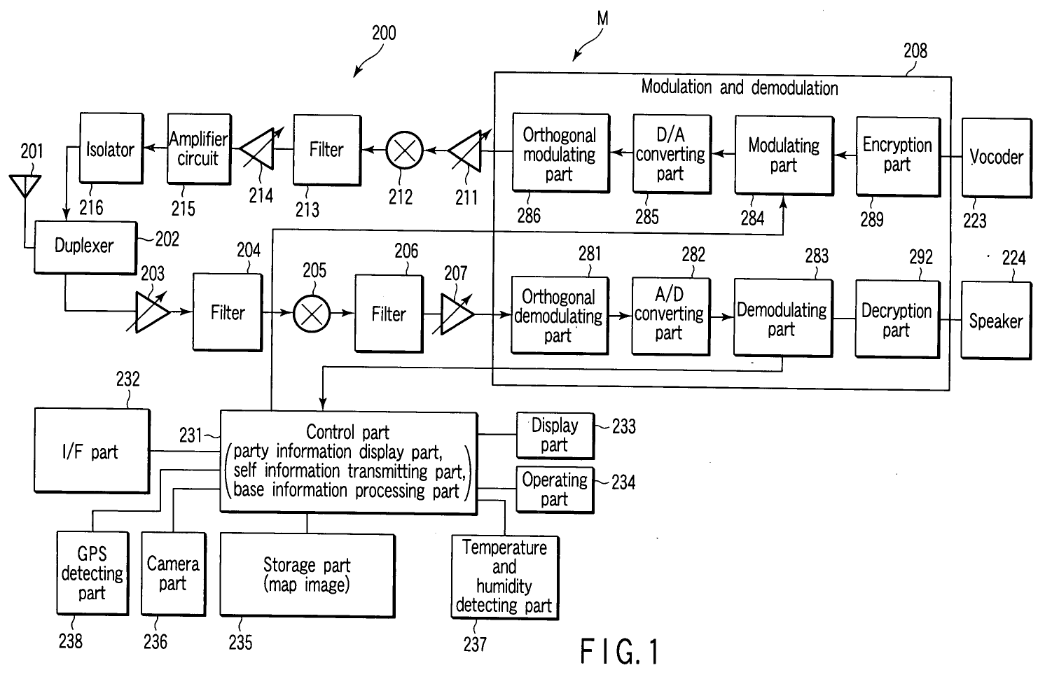

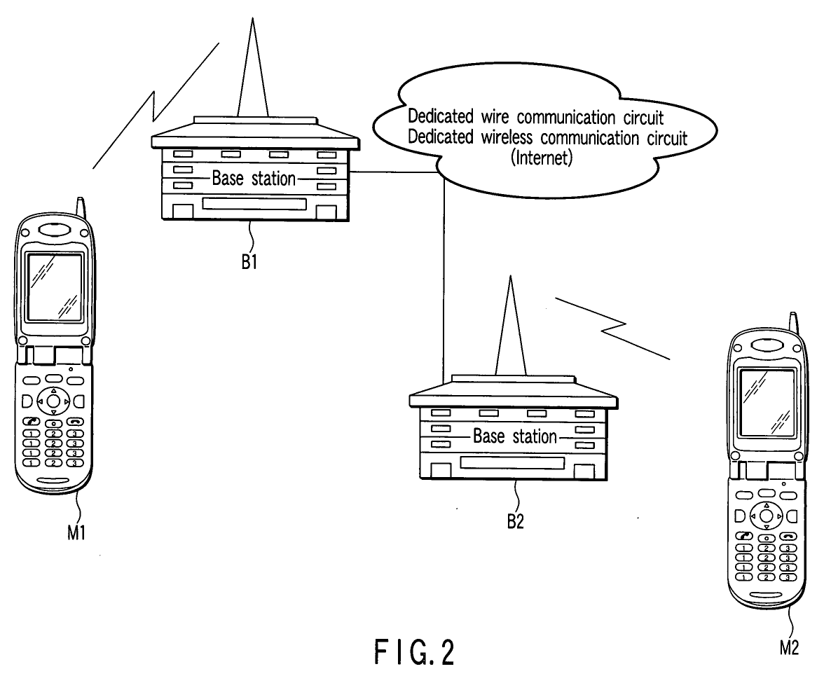

With respect to a mobile telephone device as an embodiment of the present invention, FIG. 1 is a block diagram showing an example of the configuration of a mobile telephone device according to an embodiment of the present invention, and FIG. 2 is an explanatory view for explaining an example of the condition in which the mobile telephone device according to this embodiment makes a call to another mobile telephone device.

< Mobile Telephone Device According to an Embodiment of the Present Invention>

The mobile telephone device configuring an information reproducing system, which is an embodiment of the present invention, will be described below with reference to the drawings. A mobile telephone device M has a communication part 200, an antenna 201, a duplexer 202, an RF receiving gain variable amplifier 203, an RF band limiting filter 204, a frequency converter 205, a IF band limiting filter 206, an IF receiving gain variable amplifier 207, a modulating and demodulating part 208, an IF transmitting gain variable amplifier 211, a frequency converter 212, an RF band limiting filter 213, an RF transmission gain variable amplifier 214, a power amplifier 215, an isolator 216, a vocoder 223, and a speaker 224.

In addition, the mobile telephone device M has a control part 231 controlling the entire operation and having a party information display function, a self information transmitting function, and a base information processing function or the like, an I/F part 232 for connection to the outside, a display part 233 connected to the control part 231 for displaying the operation information, photographs, and images or the like, a storage part 235 such as a RAM (Random Access Memory) storing at least the map information or the like, a camera part 236 such as a CCD camera element, a GPS (Global Position System) detecting part 238 having a GPS antenna, an operating part 234 having a plurality of switches, and a wireless communication part 232 such as a Bluetooth I/F. Here, the GPS is a system, which measures the position of a user by using twenty-four satellites and a ground control station, and this system can measure the present position by the meter by measuring the position of the user depending on a difference of arrival time of an electric wave from four or more satellites.

In addition, the modulating and demodulating part 208 is configured by, for example, an orthogonal demodulating part 281, an A/D converting part 282, an information signal demodulating part 283, and a decryption part 292, and further, it is configured by an encryption part 289 for encrypting a signal from the vocoder 223, an information signal modulating part 284, a D/A converting part 285, and an orthogonal modulating part 286. In this configuration, the signal that is orthogonal-demodulated by the orthogonal demodulating part 281 is A/D-converted by the A/D converting part 282, demodulated into an information signal by the information signal demodulating part 283, and further decoded by the decryption part 292 to be outputted.

In such a configuration of this mobile telephone device M, the reception processing will be described below. A forward link signal to be transmitted from a base station is received by the antenna 201, supplied to a circuit at the side of a receiver by the duplexer 202, and amplified or attenuated by the RF transmitting gain variable amplifier 203. Further, the unnecessary component of this signal is filtered by the RF band limiting filter 204, the frequency of this signal is converted from an RF band into an IF band by the frequency converter 205, the unnecessary component of this signal is filtered by the IF band limiting filter 206, and this signal is amplified or attenuated by the IF receiving gain variable amplifier 207 to be inputted in the modulating and demodulating part 208.

The modulating and demodulating part 208 is configured by, for example, the orthogonal demodulating part 281, the A/D converting part 282, the information signal demodulating part 283, the information signal modulating part 284, the D/A converting part 285, and the orthogonal modulating part 286.

In this case, the encryption part 289 and the decryption part 292 are preferably encrypted and decrypted by the common encryption key information so as to prevent unauthorized interception of the voice information that is telephoned by the encryption processing. However, in a narrow sense, the encryption key information for encryption from the mobile telephone device at the transmission side and the key information with respect to the decryption part 292 at the reception side may be common.

The reception processing of the mobile telephone device M having this configuration will be described below. In accordance with the operation information to be given from the operating part 234 of a user depending on the display of the operation information of the display part 233, the following operations will be carried out according to the operation control of the control part 231. In other words, the signal that is orthogonal-demodulated by the orthogonal demodulating part 281 is A/D-converted by the A/D converting part 282, demodulated into an information signal by the information signal demodulating part 283, and further decoded by the decryption part 292 to be outputted to the speaker 224 as the voice.

Further, to explain the transmission processing of this mobile telephone device M below, in the same way, in accordance with the operation information to be given from the operating part 234 of a user depending on the display of the operation information of the display part 233, the following operations will be carried out according to the operation control of the control part 231. In other words, a reverse link signal to be transmitted from a mobile station is given from the vocoder 223 and this is encrypted by the encryption part 289. This encrypted signal is modulated by the information signal modulating part 284 to be outputted, D/A converted by the D/A converting part 285, orthogonal-modulated by the orthogonal modulating part 286, and amplified or attenuated by the IF transmitting gain variable amplifier 211. Further, the frequency of this signal is converted from the IF band into the RF band by the frequency converter 212, the unnecessary component of this signal is filtered by the RF band limiting filter 213, this signal is amplified or attenuated by the RF receiving gain variable amplifier 214, the signal is amplified by the power amplifier 215, and it is supplied to the antenna 201 by the duplexer 202 via the isolator 216 to be transmitted to space.

In addition, by applying such transmission and reception processing, this mobile telephone device M can be connected to the Internet via a base station B, so that the information can be transmitted and received to and from a desired server S or the like designating an URL and e-mail or the like can be used.

< Display Processing of Dynamic Information of Mobile Cellular Phone According to an Embodiment of the Present Invention>

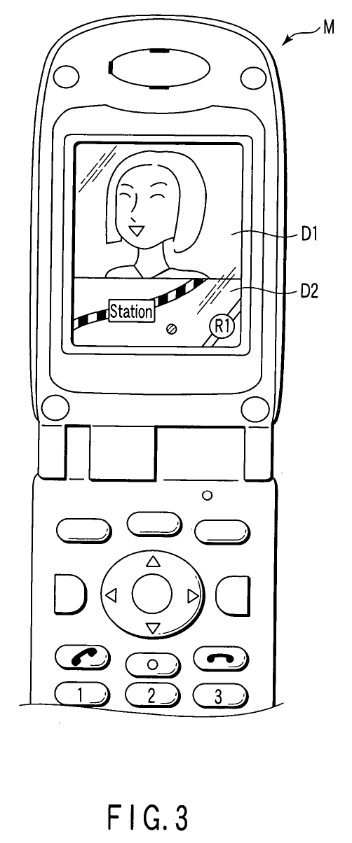

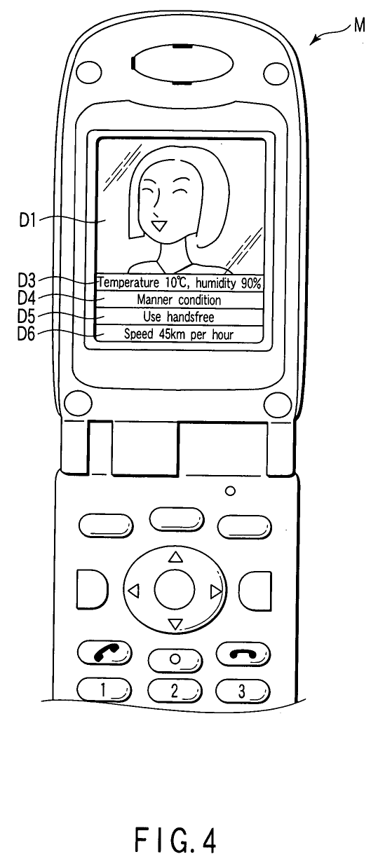

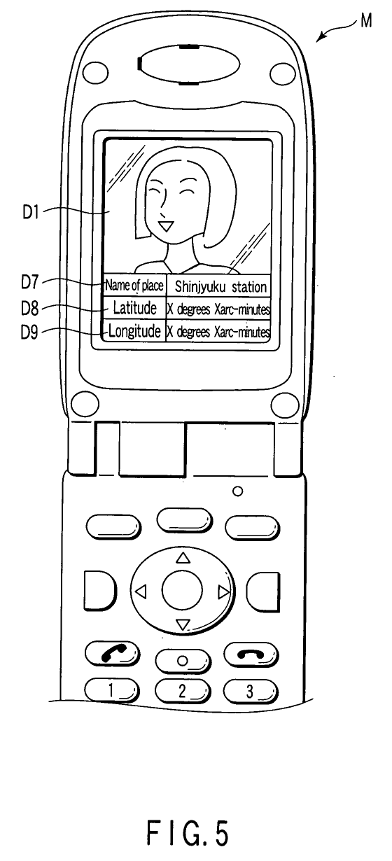

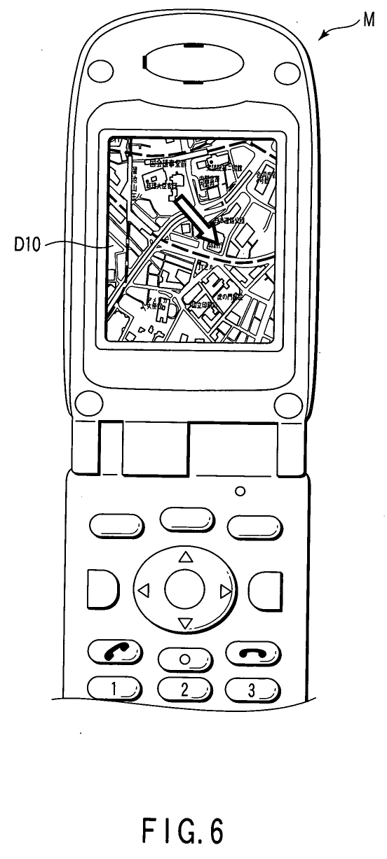

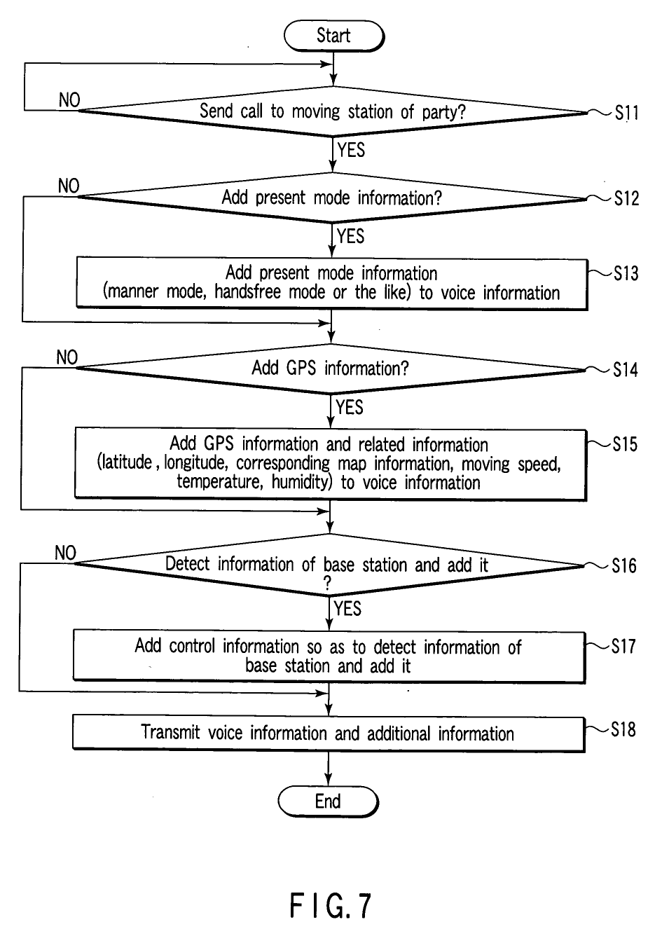

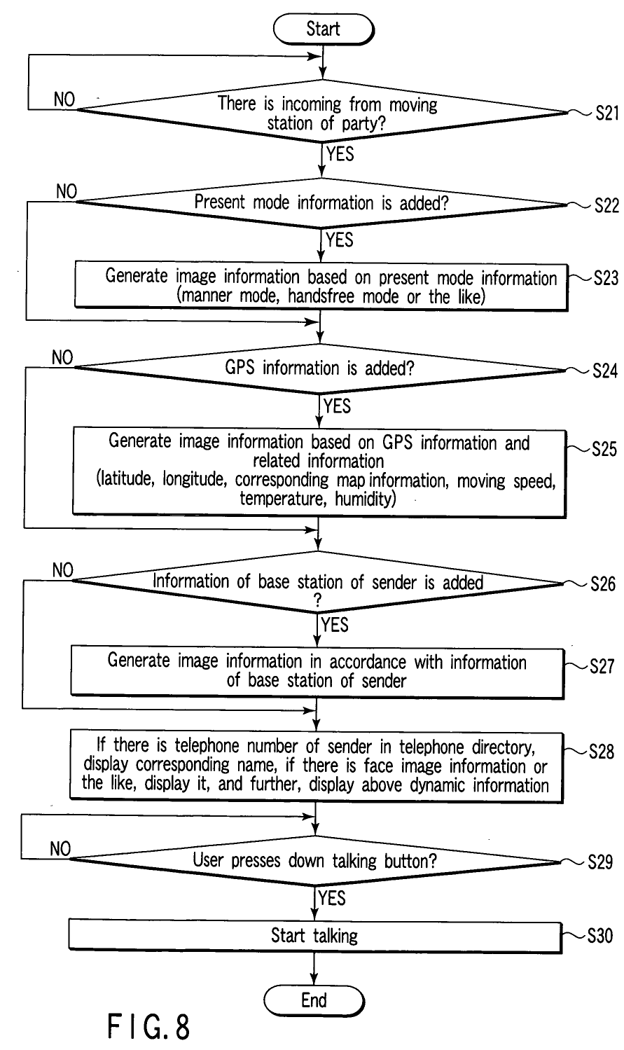

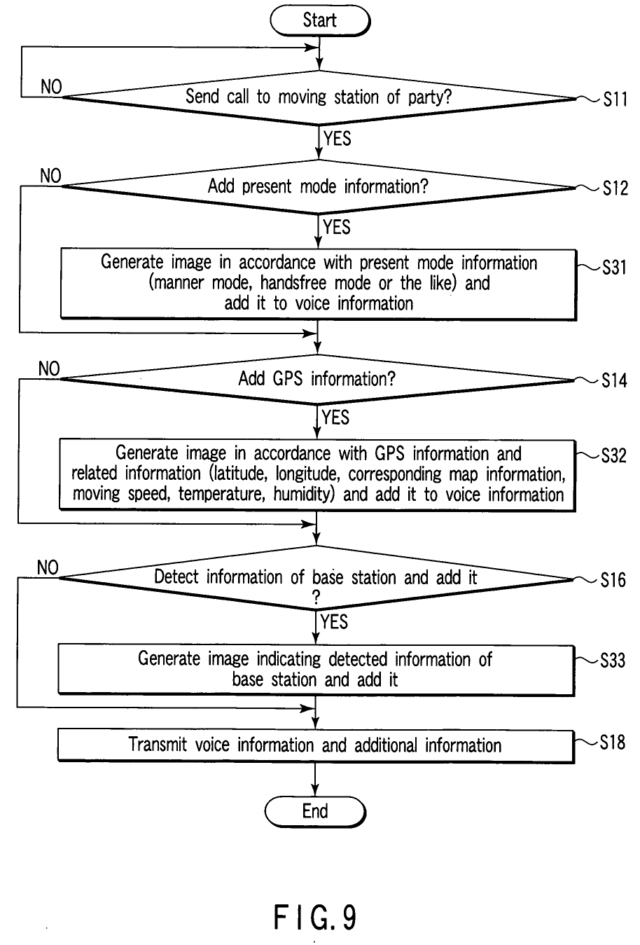

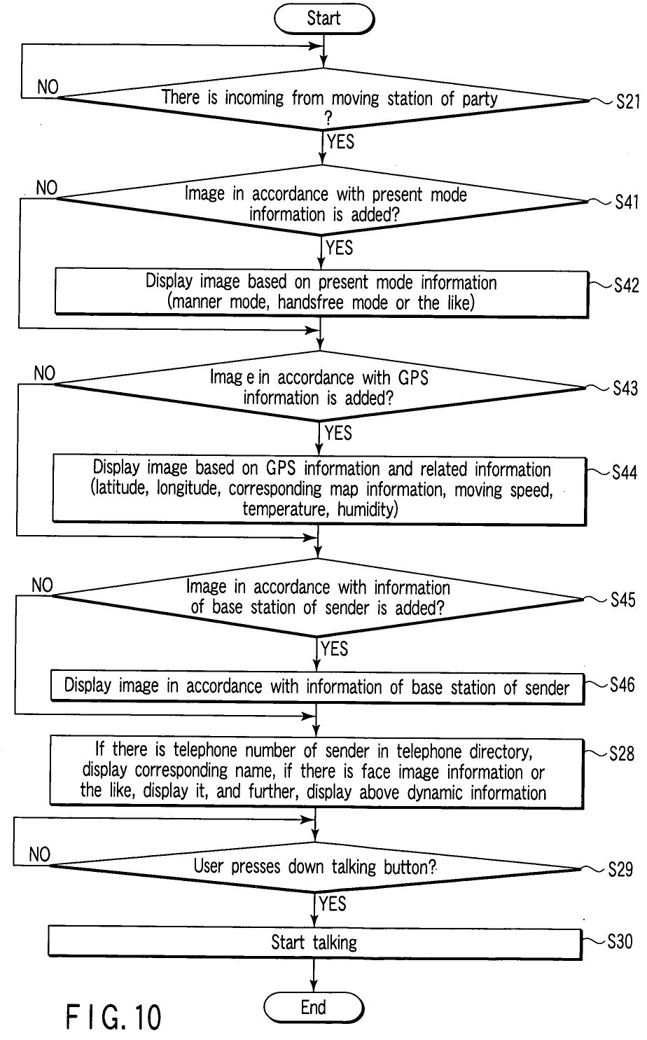

Next, the display processing of the dynamic information according to an embodiment of the present invention will be described in detail with reference to the drawings. FIG. 3 is a view showing an example in which the mobile telephone device according to the embodiment of the present invention displays the map information in accordance with the face image and the GPS positional information; FIG. 4 is a view showing an example in which the mobile telephone device according to this embodiment displays the face information and the usage condition; FIG. 5 is a view showing an example in which the mobile telephone device according to this embodiment displays the map information in accordance with the face image and the positional information; FIG. 6 is a view showing an example in which the mobile telephone device according to this embodiment displays the map information in accordance with the positional information; FIG. 7 is a flow chart showing an example of the processing of the mobile telephone device upon calling according to this embodiment; FIG. 8 is a flow chart showing an example of the processing of the mobile telephone device upon incoming and talking according to this embodiment; FIG. 9 is a flow chart showing another example of the processing of the mobile telephone device upon calling according to this embodiment; and FIG. 10 is a flow chart showing another example of the processing of the mobile telephone device upon incoming and talking according to this embodiment.

< Transmission Processing of Dynamic Information>

According to a display method of the dynamic information of the embodiment of the present invention, if there is the information related to the operation mode of the mobile telephone device of the sender in the communication information in which the incoming is detected, the mobile telephone device at the incoming side will wait for pressing down of a talking button while displaying this information on the display part together with the incoming notice. For this purpose, the dynamic information should be generated by a mobile telephone device M1 at the sender side.

In other words, according to the mobile telephone device of the present invention, as shown in FIG. 2, the talking processing is carried out by using a base station B1 near the mobile telephone device M1 of the sender and a base station B2 near the mobile telephone device M2 of the receiver. In this case, an IP telephone is also preferable, in which the method of the base station to base station communication in the mobile telephone device is carried out by the Internet. In addition, it is also preferable that the communication method of the base station to base station communication is carried out by a dedicated wire communication, and at the same time, the dedicated wireless communication is also preferable. Further, these three methods may be partially combined.

Under such a condition, upon incoming (or during a call), for example, as shown in FIGS. 3 to 6, the image of the sender, a simple map image according to the GPS or the base station, the information about a temperature and a humidity, the operation mode such as a manner mode and a handsfree mode, a moving speed using the GPS or the base station, a place name according to the GPS or the base station, and a latitude, a longitude, and a detailed map image or the like according to the GPS or the base station are displayed.

At first, according to the flow chart of FIG. 7, the processing of the mobile telephone device M1 of the sender will be described. To start with, the transfer processing of the dynamic information according to the present invention is one of the operational modes to be carried out by the user's arbitrary setting. According to these processing, the image of the sender, a simple map image according to the GPS or the base station, the information about a temperature and a humidity, the operation mode such as a manner mode and a handsfree mode, a moving speed using the GPS or the base station, a place name according to the GPS or the base station, and a latitude, a longitude, and a detailed map image or the like according to the GPS or the base station are displayed.

In other words, if a telephone number is given and the sending operation is effected when the sender sends a call to the mobile telephone device M2 of the party (S11), and if the display mode of the dynamic information is selected at the present (this mode can be arbitrarily selected by the user), it is determined whether the present dynamic mode information should be added or not (S12). In other words, the user selects the dynamic information display mode, and further, sets the present mode information (the manner mode, the handsfree mode or the like) for the items to be displayed. Then, if the manner mode and the handsfree mode or the like are selected in the present operation mode according to this setting, the control part 231 may overlap the information indicating that these modes are selected on the output of the modulation part 284 so as to add this information to the modulated voice signal (S13). In the same way, at this stage, the temperature and humidity information from a temperature and humidity detecting part 237 is overlapped on the output of the modulation part 284 via the control part 231.

In the same way, in the case where the mobile telephone device M1 is set so as to add the GPS information and other information to the voice information (S14), the positional information and the related information (the latitude, the longitude, the corresponding map image, the moving speed, and the temperature and humidity or the like) in accordance with the output of the incorporated GPS detecting part 238 are overlapped on the output of the modulation part 284 (S15). In the same way, by calculating the change amount of the output of the GPS detecting part 238 every certain seconds, the moving speed of the sender can be calculated, so that it is also preferable to overlap this moving speed information.

Further, when it is selected to detect the information of the base station (the positional information and others) and add it in the previous setting (S16), the base station B1 of FIG. 2 is accessed by using the communication function of the communication part 200, and the positional information of the base station and others are acquired here and the acquired positional information of the base station and others are overlapped on the output of the information signal modulating part 284 to be added to the modulated voice signal again (S17). Then, the modulated voice information and the additional information as the above-described dynamic information are transmitted to the mobile telephone device M2 of the party by the communication part 200 through the base station B1 and the base station B2 (S18).

(Display Processing of Dynamic Information)

Next, the display processing of the dynamic information, which has been thus transmitted, will be described in detail below with reference to the flow chart of FIG. 8. In other words, if the mobile telephone device M2 receives a call from the mobile telephone device M1 which is a mobile station of the party (S21), and if a dynamic information display mode is selected by the user on a setting screen, the display processing of the dynamic information is carried out. The transmitted additional information is acquired from the demodulation part 283 and analyzed by a party information display function of the control part 231. Further, if it is determined that the present operational mode information is added to the modulated signal (S22), the image information based on the added present mode information (the manner mode, the handsfree mode or the like) is generated (S23). In other words, as shown in FIG. 4, a image information indicating face image display D1, a temperature and humidity display D3, a manner mode display D4, a handsfree mode display D5, and a moving speed display D6 is displayed according to the effect of the party information display function of the control part 231.

In the same way, if the control part 231 determines that the GPS information is added to the modulated signal (S24), the control part 231 may generate the image information based on the GPS information and the related information (the latitude, the longitude, and the corresponding map image or the like) (S25). This composes a display screen of place name information D7, latitude information D8, and longitude information D9 shown in FIG. 5. Further, under the effect of the party information display function of the control part 231 on the basis of the latitude information and the longitude information of the GPS information, it is preferable to detect the map information in accordance with these latitude and longitude from the storage part 235 and to make it into simple map information D2 shown in FIG. 3. In addition, it is also preferable to detect not only the simple map information but also the image information D10 of the detailed map information in accordance with these latitude and longitude as shown in FIG. 6 from the storage part 235 in the same way to be generated for display (S25).

Further, when the positional information of the base station of the sender is added to the modulated signal (S26), the images of the simple map information D2 shown in FIG. 3, the place name display D7 in FIG. 5, the latitude display D8, the longitude display D9, and the image information D10 of the detailed map information or the like are formed (S27). In the same way, if there is further the face image information, the image information indicating face image display D1 shown in FIG. 4 or the like is generated to be displayed on the display together with the above-described display information D2 to D10 of the dynamic information (S28). In addition, in this case, the telephone number of the sender is also noticed, and if a name corresponding to this telephone number is shown in a telephone directory recorded in the storage part 235, it is preferable that the sender's name is displayed on the screen at the same time.

Thereby, the user who receives the incoming can totally know the condition of the sender from the present operation mode, the positional information of the sender, the image information such as the added face image or the like. Therefore, even if there is no telephone number of the sending party in the telephone directory, the user can predict the incoming party. In addition, for example, in FIG. 4, the user can considerably know the appearance of the sender such as the fact that the sender makes a call when driving a car at a speed of 45 km/h in the handsfree mode from the sender's face image and the present condition of the temperature 10° C. (cool) and the humidity 90% (rain). Thus, it becomes possible to determine if the user should answer the phone or not with accuracy.

< Other Display Processing of Dynamic Information (Image Formation at Sender's Side)>

Next, according to the above explanation, the image formation processing of the dynamic information is carried out by the mobile telephone device M2 at the incoming side in the above-described display processing of the dynamic information. However, this image formation processing also can be carried out by the mobile telephone device M1 at the sender's side. The flow charts shown in FIGS. 9 and 10 illustrate that the mobile telephone device M1 at the sender's side may carry out the image formation processing of the dynamic information and the mobile telephone device M2 at the receiver's side may display the transmitted image information on the display part 233 as it is. The explanation of the processing that is common to the flow charts of FIGS. 7 and 8 is herein omitted because it is the common step.

In other words, in the mobile telephone device M1, as shown in FIG. 9, when the present mode information is set to be added to the modulated signal in step S12, if the manner mode and the handsfree mode or the like are selected in the present operation mode, the control part 231 may generate the image information D4 and D5 as shown in FIG. 4 for displaying the fact that these modes are selected on the screen. Then, it may overlap these image information on the output of the modulation part 284 in order to add them to the modulated voice signal (S31). Thereby, even when the mobile telephone device M2 does not correspond to the conventional dynamic information display mode, only if there is the image display function, the user can carry out the display processing of the dynamic information of the sender.

In addition, the positional information and the related information (the latitude, the longitude, the corresponding map image, the moving speed, and the temperature and humidity or the like) in accordance with the output of the incorporated GPS detecting part 238 are overlapped on the output of the modulation part 284 in the same way (S32).

In addition, when detecting the positional information of the base station or the like and adding it (S16), the image indicating the information of the base station detected under the control of the control part 231, for example, the simple map information D2 shown in FIG. 3, the place name display D7 in FIG. 5, the latitude display D8, the longitude display D9, and the detailed map display D10 is generated on the basis of the map information or the like of the storage part 235 to be supplied to the modulation part 284 and added to the modulation signal (S33).

In addition, in the mobile telephone device M2, the image formation processing is carried out by the procedure as shown in FIG. 10, however, without carrying out the image formation basically, the added image is controlled to be displayed. In other words, upon incoming from the mobile telephone device M1 of the party (S21), if the image in accordance with the present mode information is added (S41), the image information on the basis of the present added mode information (the manner mode, the handsfree mode or the like) is displayed (S42). In other words, as shown in FIG. 4, image information indicating face image display D1, a temperature and humidity display D3, a manner mode display D4, a handsfree mode display D5, and a moving speed display D6 is generated according to the effect of the party information display function of the control part 231.

In the same way, if the image corresponding to the GPS information is added (S43), the mobile telephone device M2 may display the image screen as shown in FIG. 4 on the basis of these GPS information and related information (the latitude, the longitude, the corresponding map image, the moving speed, and the temperature and humidity or the like) (S44). Further, if the image in accordance with the information of the sender's base station is added to a demodulation screen (S45), the mobile telephone device M2 may display the image in accordance with the information of the sender's base station (S46).

Thus, in the mobile telephone device M2 at the incoming side, even if the user does not have the image formation function to form the image from the dynamic information, the image information for display has been already generated by the mobile telephone device M1 at the sender's side to be transmitted. Accordingly, with only the display function upon incoming, for example, the model of the old version and the model of other manufacturers also can use the display function of the dynamic information.

In the meantime, in the above explanation, the embodiments are described based on the mobile telephone device (the cellular phone). However, the present invention is not limited to the mobile telephone device and in the case where one party uses a fixed phone (for example, including the case that the TV phone function is loaded in the TV at home), as shown in the flow charts of FIGS. 7 to 10, the present invention can be effected according to the same procedure. Further, in the case where the both parties uses the fixed phone, the user can notice the dynamic condition of himself or herself to other party according to the same operational procedure. Thereby, in the case of calling from the fixed phone, the function to add the GPS information, the environment information, and the operation mode or the like depending on the setting is useful for the user because the incoming side can predict the condition of other party.

As described above in detail, the mobile telephone device according to the present invention may display the dynamic information of the sender, in this case, the operational mode (the manner mode and the handsfree mode) presently used upon incoming. Thereby, by noticing various information of the sender who presently receives the call to other party, the present mobile telephone device can instantaneously notice the condition (who the sender is, the sender is moving (driving the car), and the sender is on the business trip at the present) to other party.

According to the above-described various embodiments, a person skilled in the art can realize the present invention. Further, a person skilled in the art could easily make various modified examples of these embodiments and without inventive capabilities, could apply the present invention to various embodiments. For example, in the above-described embodiments, a voice file or the like is mainly described, however, the embodiments of the present invention are not limited to this but they cover the general digital information including the moving image file and the database or the like. Accordingly, the present invention covers a broad range that is consistent with the disclosed principle and a new characteristic, so that the present invention is not limited to the above-described embodiments.

What is claimed is:

1. A mobile telephone device comprising:
a communication part configured to perform wireless communication with an external mobile telephone device;
a talking part configured to make a call to the external mobile telephone device by modulating a voice signal from a vocoder, transmitting it from the communication part, demodulating the voice signal received by the communication part, and reproducing it by a speaker;
a display part configured to display an image in accordance with communication information received by the communication part through wireless communication; and
a control part configured to display information related to an operational mode of the mobile telephone device of a sender together with an incoming notice if there is this information among the communication information of which incoming is detected by the communication part and to control the mobile telephone device so as to wait for an operation for talking.

2. The mobile telephone device according to claim 1, wherein the operational mode of the sender information is at least one of a manner mode and a handsfree mode.

3. The mobile telephone device according to claim 1, wherein, when receiving information related to positional information of the mobile telephone device of the sender from a communication party, the mobile telephone device displays this on the display part.

4. The mobile telephone device according to claim 1, wherein, when receiving a signal having positional information from a communication party as the sender information, the mobile telephone device reads out map information corresponding to the positional information and displays this map image on the display part.

5. The mobile telephone device according to claim 1, further comprising:
an image formation part configured to form an image in accordance with the sender information in order to transmit the image information in accordance with the sender information from the communication part.

6. The mobile telephone device according to claim 1, wherein the control part acquires the positional information of the base station with which the communication part performs communication through communication, and controls the mobile telephone device so as to transmit the present positional information of the mobile telephone device of the sender based on the positional information of this base station to the external mobile telephone device.

7. The mobile telephone device according to claim 1, wherein the mobile telephone device further has a detecting part configured to detect the present positional information of the mobile telephone device of the sender by performing the communication with other communication device, and thereby, the control part controls the mobile telephone device so as to transmit the detected latitude and longitude to the external mobile telephone device by using the communication part.

8. The mobile telephone device according to claim 1, wherein the mobile telephone device further has a detecting part configured to detect the present positional information of the mobile telephone device of the sender by performing the communication with other communication device, and thereby, the control part controls the mobile telephone device so as to transmit map image information in accordance with the detected present positional information to the external mobile telephone device by using the communication part.

9. The mobile telephone device according to claim 1, wherein the mobile telephone device further has a detecting part configured to detect the present positional information of the mobile telephone device of the sender by performing the communication with other communication device, a moving speed is calculated by measuring the present positional information every certain seconds, and the control part controls the mobile telephone device so as to transmit the moving speed to the external mobile telephone device by using the communication part.

10. The mobile telephone device according to claim 1, wherein
the mobile telephone device further has a detecting part configured to detect a temperature or a humidity in air and
the control part controls the mobile telephone device so as to transmit the information about the detected temperature or humidity to the external mobile telephone device by using the communication part.

11. A telephone method of a mobile telephone device, comprising:
performing wireless communication with an external mobile telephone device, and
if there is information related to an operational mode of the mobile telephone device of a sender among communication information of which incoming is detected, displaying it on a display part together with an incoming notice and waiting for an operation for talking.

12. The telephone method according to claim 11, wherein the operational mode of the sender information is at least one of a manner mode and a handsfree mode.

13. The telephone method according to claim 11, wherein, when receiving information related to positional information of the sender information from a communication party, this is displayed on the display part of the mobile telephone device.

14. The telephone method according to claim 11, wherein, when receiving a signal having positional information as the sender information from a communication party, a map image in accordance with the positional information is read out from a storage area and this map image is displayed on the display of the mobile telephone device.

15. The telephone method according to claim 11, wherein image formation is carried out in accordance with the sender information in order to add the image information in accordance with the sender information to the carrier wave.

16. The telephone method according to claim 11, wherein positional information of a base station in which the mobile telephone device of the sender performs communication is acquired through communication, and the present positional information of the mobile telephone device of the sender on the basis of the positional information of this base station is transmitted to the external mobile telephone device.

17. The telephone method according to claim 11, wherein present positional information of the mobile telephone device of the sender is detected through communication to other communication device, and the detected latitude and longitude are transmitted to the external mobile telephone device.

18. The telephone method according to claim 11, wherein present positional information of the mobile telephone device of the sender is detected through communication with other communication device and the mobile telephone device is controlled so as to transmit map image information in accordance with the detected present positional information to the external mobile telephone device.

19. The telephone method according to claim 11, wherein present positional information of the mobile telephone device of the sender is detected through communication with other communication device, a moving speed is calculated by measuring the present positional information every certain seconds, and the mobile telephone device is controlled so as to transmit the moving speed to the external mobile telephone device.

20. A telephone method of a telephone device, comprising:
performing wireless communication with an external mobile telephone device, and
if there is information related to an operational mode of the mobile telephone device of a sender among communication information of which incoming is detected, displaying it on a display part together with an incoming notice and waiting for an operation for talking.
